(19) United States
(12) Patent Application Publication
(10) Pub. No.: US 2023/0259769 A1
(43) Pub. Date: Aug. 17, 2023

(54) MULTI-STAGE TRAINING OF MACHINE LEARNING MODELS

(71) Applicant: X Development LLC, Mountain View, CA (US)

(72) Inventors: Akshina GUPTA, Warren, NJ (US); Elito Julien Cowan, Atherton, CA (US); Krishna Kumar Rao, Stanford, CA (US)

(21) Appl. No.: 18/168,027

(22) Filed: Feb. 13, 2023

Related U.S. Application Data
(60) Provisional application No. 63/310,808, filed on Feb. 16, 2022.

(51) Int. Cl. G06N 3/08

(52) U.S. Cl. CPC G06N 3/08

(57) ABSTRACT

Methods, systems, and apparatus, including computer programs encoded on a computer storage medium, for training a machine learning model to perform a machine learning task. In one aspect, a method includes: obtaining a set of training examples; obtaining, for each training example, a respective metadata label that characterizes the training example; and training the machine learning model over a sequence of training stages, including, at each training stage: identifying a selection criterion corresponding to the current training stage that defines a criterion for selecting training examples based on the metadata labels of the training examples; selecting a proper subset of the set training examples as training data for the current training stage in accordance with the selection criterion for the current training stage; and updating the machine learning model by training the machine learning model on the training data for the current training stage.

### CROSS REFERENCE TO RELATED APPLICATION

This application claims priority under 35 U.S.C. 119 to Provisional Application No. 63/310,808, filed Feb. 16, 2022, which is incorporated by reference.

### BACKGROUND

This specification relates to processing data using machine learning models.

Machine learning models receive an input and generate an output (e.g., a predicted output) based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a training system implemented as computer programs on one or more computers in one or more locations that trains a machine learning model to perform a machine learning task.

According to a first aspect, there is provided a method performed by one or more computers for training a machine learning model to perform a machine learning task, the method comprising: obtaining a set of training examples; obtaining, for each training example, a respective metadata label that characterizes the training example; and training the machine learning model over a sequence of training stages, comprising, at each training stage before a last training stage in the sequence of training stages: identifying a selection criterion corresponding to the current training stage that defines a criterion for selecting training examples based on the metadata labels of the training examples, selecting a proper subset of the set training examples as training data for the current training stage in accordance with the selection criterion for the current training stage, updating the machine learning model by training the machine learning model on the training data for the current training stage, and providing the updated machine learning model for further training at a next training stage in the sequence of training stages. Other implementations of this aspect include corresponding systems, apparatus, and computer programs, configured to perform the actions of the methods, encoded on computer storage devices.

These and other implementations can each optionally include one or more of the following features.

In some implementations, for each training example, the metadata label for the training example defines a timestamp corresponding to the training example.

In some implementations, for each training example, the metadata label for the training example defines a geographic feature corresponding to the training example.

In some implementations, for each training stage in the sequence of training stages: the selection criterion corresponding to the training stage specifies a set of allowable metadata labels for the training stage; and each training example is eligible for selection at the training stage only if the metadata label of the training example is included in the set of allowable metadata labels for the training stage.

In some implementations, for each training stage after a first training stage in the sequence of training stages: a maximum metadata label in the set of allowable metadata labels for the training stage is greater than a maximum metadata label in the set of allowable metadata labels for a preceding training stage.

In some implementations, for one or more training stages in the sequence of training stages: the selection criterion corresponding to the training stage specifies a respective selection weight for each metadata label in the set of allowable metadata labels; and selecting a proper subset of the set of training examples as training data for the current training stage comprises: determining a probability distribution, over training examples having metadata labels included in the set of allowable metadata labels for the training stage, using the selection weights for the allowable metadata labels; and sampling a plurality of training examples having metadata labels included in set of allowable metadata labels in accordance with the probability distribution.

In some implementations, for one or more training stages in the sequence of training stages: the set of allowable metadata labels for the training stage comprises a plurality of metadata labels; and the selection criterion corresponding to the training stage specifies a higher selection weight for a maximum metadata label in the set of allowable metadata labels than for a minimum metadata label in the set of allowable metadata labels.

In some implementations, for one or more training stages in the sequence of training stages, updating the machine learning model by training the machine learning model on the training data for the current training stage comprises: determining, for each training example in the training data for the current training stage, an error in a prediction generated by the machine learning model for the training example; updating the machine learning model using the errors in the predictions generated by the machine learning model for the training examples in the training data for the current training stage.

In some implementations, the machine learning model is an ensemble model that comprises a plurality of base models, and updating the machine learning model using the errors in the predictions generated by the machine learning model for training examples in the training data for the current training stage comprises: determining a prediction target for each training example in the training data for the current training stage based on the error in the prediction generated by the machine learning model for the training example; generating one or more new base models that are each trained to generate the prediction targets for the training examples in the training data for the current training stage; and adding the new base models to the ensemble model.

In some implementations, the new base models are decision trees.

In some implementations, updating the machine learning model using the errors in the predictions generated by the machine learning model for the training examples in the training data for the current training stage comprises: determining a respective weight factor for each training example in the training data for the current training stage based on the error in the prediction generated by the machine learning model for the training example; training the machine learning model on the training data for the current training stage using the weight factors for the training examples, wherein the weight factor for a training example controls an impact of the training example on the training of the machine learning model.

In some implementations, the machine learning model comprises a neural network, and training the machine learning model on the training data for the current training stage using the weight factors for the training examples comprises, for each training example: generating a prediction for the training example using the neural network; determining gradients, with respect to neural network parameters of the neural network, of an objective function that depends on the prediction for the training example; scaling the gradients using the weight factor for the training example; and updating the neural network parameters of the neural network using the scaled gradients.

In some implementations, training the machine learning model at the last stage in the sequence of training stages comprises: identifying a selection criterion corresponding to the last training stage that defines a criterion for selecting training examples based on the metadata labels of the training examples; selecting a proper subset of the set training examples as training data for the last training stage in accordance with the selection criterion for the current training stage; updating the machine learning model by training the machine learning model on the training data for the last training stage; and providing the updated machine learning model for use in performing the machine learning task.

In some implementations, each training example in the set of training examples comprises: (i) a training input to the machine learning model, and (ii) a target output to be generated by the machine learning model by processing the training input.

In some implementations, the machine learning model performs a fire prediction task, wherein for each training example: (i) the training input characterizes a geographic region, and (ii) the target output defines, for each of one or more spatial locations in the geographic region, whether the spatial location will be impacted by fire within a time window.

In some implementations, the machine learning model performs a flood prediction task, wherein for each training example: (i) the training input characterizes a geographic region, and (ii) the target output defines, for each of one or more spatial locations in the geographic region, whether the spatial location will be impacted by flooding within a time window.

In some implementations, the machine learning model performs a health prediction task, wherein for each training example: (i) the training input comprises electronic medical record data characterizing a subject, and (ii) the target output defines a prediction for whether the subject will receive a medical diagnosis within a time window.

In some implementations, for each training example, the training input to the machine learning model comprises an image, or features derived from an image.

Particular implementations of the subject matter described in this specification can be implemented so as to realize one or more of the following advantages.

The training system described in this specification can train a machine learning model on a set of training examples. Each training example includes: (i) a training input to the machine learning model, and (ii) a target output to be generated by the machine learning model by processing the training input. Each training example is further associated with a metadata label (“meta-label”) that defines descriptive data characterizing the training example, e.g., a timestamp associated with the training example.

The training system trains the machine learning model on the training data, in particular, by training the machine learning model to learn to approximate an (unknown) ground truth mapping from training inputs to target outputs. However, the relationship between training inputs and target outputs can vary as a function of the meta-data labels of the training examples. For example, for machine learning tasks that involve making predictions that depend on the climate (e.g., fire prediction, flood prediction, precipitation prediction), the relationship between training inputs and target outputs varies as a function of time (in particular, timestamp meta-labels) due to climate change. Therefore, the training system trains the machine learning model over a sequence of training stages in a manner that explicitly accounts for trends in the distribution of the target outputs.

In particular, at each training stage in a sequence of training stages, the training system selects training data for use in training the machine learning model at the training stage in accordance with a selection criterion based on the meta-labels for the training examples. Thus the training system embeds information in the parameters of the machine learning model that enables the machine learning model to implicitly reason about trends in the distribution of the target outputs. As a result of this training, the machine learning model can achieve a higher prediction accuracy than would otherwise be possible. Moreover, the machine learning model can achieve an acceptable prediction accuracy after being trained on less training data than would otherwise be necessary, thereby enabling reduced use of computational resources (e.g., memory and computing power) during training.

Moreover, at each training stage, the training system trains the machine learning model on a proper subset of the full set of training examples. The training system thereby reduces use of computational resources at each training stage, for example, as compared to a system that trains the machine learning model on the full set of training examples at each training stage.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2A-2C illustrate examples of training data selection criteria.

FIG. 3 is a flow diagram of an example process for training a machine learning model to perform a machine learning task over a sequence of training stages.

FIG. 4 is a flow diagram of an example process for updating a machine learning model by training the machine learning model on training data for a current training stage.

Like reference numbers and designations in the various drawings indicate like elements.

### DETAILED DESCRIPTION

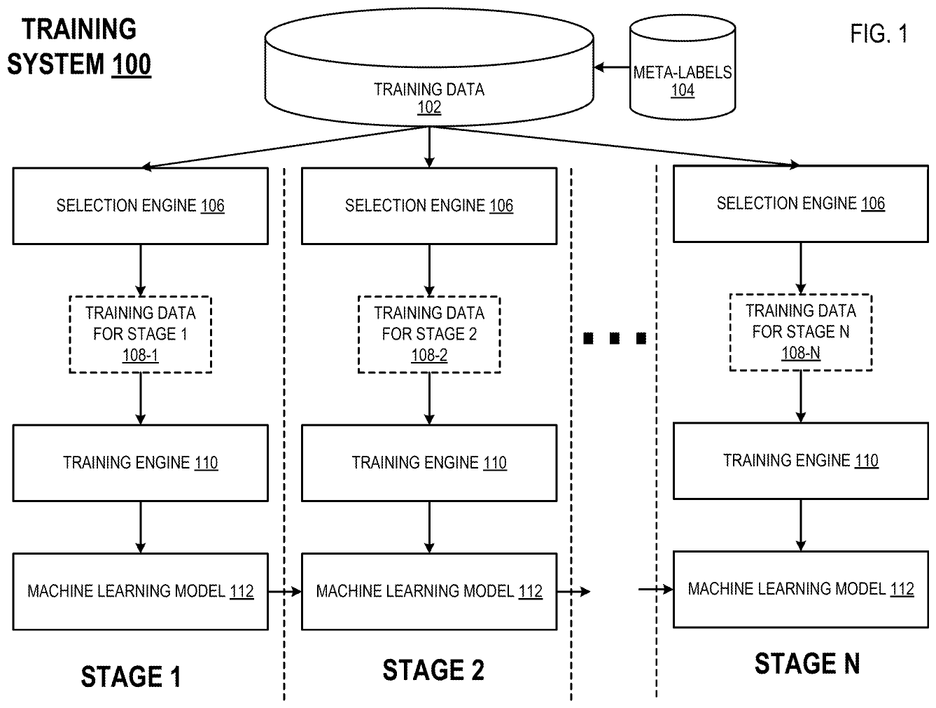

FIG. 1 shows an example training system 100. The training system 100 is an example of a system implemented as computer programs on one or more computers in one or more locations in which the systems, components, and techniques described below are implemented.

The training system 100 trains a machine learning model 112 to perform a machine learning task.

The machine learning model 112 is configured to process a model input, in accordance with values of a set of machine learning model parameters, to generate a model output. The model output can be any appropriate output, e.g., a classification output, a regression output, a segmentation output, a sequence output, or a combination thereof. Generally, the form of the model output of the machine learning model 112 depends on the machine learning task performed by the machine learning model. Examples of machine learning tasks that can be performed by the machine learning model are described in more detail below.

The machine learning model 112 can have any appropriate model architecture. A few examples of possible model architectures of the machine learning model 112 are described next.

In some implementations, the machine learning model 112 has a neural network architecture. In particular, the neural network architecture can include any appropriate types of neural network layers (e.g., fully connected layers, convolutional layers, attention layers, recurrent layers, etc.) in any appropriate number (e.g., 5 layers, 25 layers, or 100 layers) and connected in any appropriate configuration (e.g., as a linear sequence of layers).

In some implementations, the machine learning model 112 has a support vector machine architecture.

In some implementations, the machine learning model 112 has an ensemble model architecture that includes a set of “base” models. Each base model is itself a machine learning model (e.g., a decision tree model, a neural network model, a support vector machine model). Each base model in the ensemble model is configured to process the ensemble model input to generate a respective base model output, and the ensemble model combines the base model outputs to generate the ensemble model output. For example, an ensemble model can combine base model outputs to generate an ensemble model output as:

$$F ( x ) = {\sum }_{i = 1}^{M} {γ}_{i} \cdot {f}_{i} ( x ) \qquad ( 1 )$$

where x is the ensemble model input, F(x) is the ensemble model output, M is the number of base models in the ensemble model, i indexes the base models in the ensemble model, (γᵢ)ᵢ₌₁^{M} are scaling factors, and (fᵢ(x))ᵢ₌₁^{M} are the base model outputs.

The machine learning model 112 can perform any of a variety of appropriate machine learning tasks. A few examples of possible machine learning tasks are described next.

In some implementations, the machine learning model 112 performs a fire prediction task. In particular, the machine learning model can generate a model output that defines, for each of one or more spatial locations in an environment (e.g., geographic region), a respective likelihood that the spatial location will experience damage due to fires (e.g., wildfires) within a future time window (e.g., 6 months, 1 year, 5 years). Each spatial location can represent a predefined area (e.g., 100 square meters, 500 square meters, 1000 square meters) in the environment. The model input to the machine learning model can include, for each spatial location, data characterizing one or more of: elevation of the spatial location; wind patterns at the spatial location; vegetation at the spatial location; rainfall at the spatial location; temperature at the spatial location; humidity at the spatial location; etc. The model input can also include one or more images of the environment (e.g., photographic images, infrared images, hyperspectral images, etc.), or features derived from one or images of the environment.

In some implementations, the machine learning model 112 performs a flood prediction task. In particular, the machine learning model can generate a model output that defines, for each of one or more spatial locations in an environment (e.g., geographic region), a respective likelihood that the spatial location will experience flooding within a future time window (e.g., 6 months, 1 year, 5 years). Each spatial location can represent a predefined area (e.g., 100 square meters, 500 square meters, 1000 square meters) in the environment. The model input to the machine learning model can include, for each spatial location, data characterizing one or more of: elevation of the spatial location; soil at the spatial location (e.g., the density and porosity of the soil at the location); rainfall in a vicinity of the spatial location; etc. The model input can also include one or more images of the environment (e.g., photographic images, infrared images, hyperspectral images, etc.), or features derived from one or images of the environment.

In some implementations, the machine learning model 112 performs a precipitation prediction task. In particular, the machine learning model 112 can generate a model output that defines, for each of one or more spatial locations in an environment (e.g., geographic region), a predicted amount of precipitation (e.g., measured in millimeters of rain or inches of snow) at the spatial location over a future time window (e.g., 1 month, 3 months, 6 months). Each spatial location can represent a predefined area (e.g., 100 square meters, 500 square meters, 1000 square meters) in the environment. The model input to the machine learning model can include, for each spatial location, data characterizing one or more of: geographic features at the spatial location (e.g., elevation at the spatial location); and historical weather patterns at the spatial location (e.g., historical temperature, humidity, wind, precipitation patterns) at the spatial location. The model input can also include one or more images of the environment (e.g., photographic images, infrared images, hyperspectral images, etc.), or features derived from one or images of the environment.

In some implementations, the machine learning model 112 performs a demand prediction task. In particular, the machine learning model can generate a model output that defines, for each of one or more future time points, an estimate for demand for resources at the future time point. The resources can include, e.g., computing resources (e.g., in a data center), or material resources (e.g., in a supply chain), or natural resources (e.g., water resources), or energy resources (e.g., on an electrical grid). The model input to the machine learning model can include data characterizing one or more of: previous demand for the resources (e.g., over the past 1 month, 6 months, 1 year); economic trends (e.g., predicted growth in gross domestic product (GDP)); climate trends (e.g., predicted maximum temperature in a future time window); etc.

In some implementations, the machine learning model 112 performs a health prediction task. For example, the machine learning model can generate a model output that defines, for example, a likelihood that a subject will receive a medical diagnosis (e.g., diabetes, heart disease, dementia, etc.) within a future time window. The model input to the machine learning model can include data characterizing electronic medical records of the subject, for example, including one or more of: medical images of the subject (e.g., magnetic resonance images, computed tomography images, ultrasound images, etc.); lab results for the subject; previous diagnoses of the subject; etc.

The training system 100 trains the machine learning model 112 on a set of training data 120. The training data 102 includes a set of training examples. Each training example includes: (i) a training input to the machine learning model 112, and (ii) a target output that is generated by the machine learning model 112 by processing the training input.

Each training example in the training data 102 is associated with a respective metadata label 104, or “meta-label,” that defines descriptive data characterizing the training example. A few examples of meta-labels are described next.

In some implementations, a meta-label for a training example can define a timestamp corresponding to the training example, for example, a timestamp associated with a target output of the training example. For example, for the fire prediction task described above, the target output for a training example can define whether each spatial location in a set of spatial locations experiences fire damage over a time window, and the timestamp for the training example can define the time window. As another example, for the demand prediction task described above, the target output for a training example can define demand for a resource over a time window, and the timestamp of the training example can define the time window. In a particular example, the time window can be a one year time window, and the timestamp can be, for example, “year 2000,” “year 2001,” “year 2002,” etc.

In some implementations, a meta-label for a training example can define a geographic feature corresponding to the training example, such as, for example, a geographic feature associated with the target output of the training example (e.g., an elevation feature, a distance feature). For example, for the precipitation prediction task described above, the target output for a training example can define precipitation levels in an environment, and the meta-label for the target output can define an elevation (e.g., an average elevation, measured in meters above sea level) of the environment. As another example, for the flood prediction task described above, the target output for a training example can define whether flooding occurs in an environment, and the meta-label for the target output can define a distance (e.g., an average distance, measured in meters) between the environment and a water reservoir (e.g., river, lake, ocean).

The meta-labels 104 for the training examples are drawn from a set of possible meta-labels, where the set of possible meta-labels is associated with an ordering. For example, each meta-label in the set of possible meta-labels can be represented by a numerical value (e.g., defining a timestamp, an elevation, a distance, etc.), and the meta-labels can be ordered in accordance with their numerical value representations.

The training system 100 trains the machine learning model 112 on the training data 102, in particular, by training the machine learning model 112 to learn to approximate an (unknown) ground truth mapping from training inputs to target outputs. However, the relationship between training inputs and target outputs can vary as a function of the meta-data labels of the training examples. For example, for machine learning tasks that involve making predictions that depend on the climate (e.g., fire prediction, flood prediction, precipitation prediction), the relationship between training inputs and target outputs varies as a function of time (in particular, timestamp meta-labels) due to climate change. Therefore, the training system 100 trains the machine learning model over a sequence of training stages in a manner that explicitly accounts for the trends in the distribution of the target outputs as a function of the meta-labels, as will be described in more detail next. It will be appreciated that the training techniques described herein may be particularly effective when the distribution of the target outputs changes gradually and smoothly with respect to the meta-label.

The training system 100 trains the machine learning model 112 on the training data 102 over a sequence of training stages (e.g., “stage 1,” “stage 2,” . . . , “stage N”).

Prior to the first training stage, the training system 100 initializes the machine learning model 112. For example, if the machine learning model 112 is a neural network model, then the training system 100 can initialize the parameter values of the machine learning model 112, for example, using a random initialization or Glorot initialization technique. As another example, if the machine learning model 112 is an ensemble model, then the training system 100 can initialize the ensemble to include a base model that is configured to generate a constant output irrespective of the input to the base model. The training system 100 can define the constant output of the base model as a measure of central tendency (e.g., average or median) of the target outputs of the training examples in the training data 102.

At each training stage in the sequence of training stages, the training system 100 updates the machine learning model 112 using a selection engine 106 and a training engine 110, which are described in more detail next.

At each training stage, the selection engine 106 selects a proper subset of the training data 102 for use in updating the machine learning model 112 at the current training stage. A “proper subset” of the training data 102 refers to a subset of the training data that comprises less than all of the training examples in the training data 102.

The selection engine 106 can select the training data 108 for each training stage in accordance with a selection criterion for the training stage. The selection criterion for a training stage can define a criterion for selecting training examples from the training data 102, based on the meta-labels 104 of the training examples. The selection engine 106 can identify the selection criterion for each training stage in any appropriate way, for example, each training stage can be associated with a predefined selection criterion.

The selection criterion for a training stage can define a criterion for selecting training examples from the training data 102 in any of a variety of ways. A few examples of possible selection criteria for a training stage are described next.

In some implementations, the selection criterion for a training stage can specify a set of allowable meta-labels for the training stage, such that only training examples with a meta-label included in the set of allowable meta-labels is eligible for selection at the training stage. The set of allowable meta-labels can include a single meta-label or a range of allowable meta-labels. For example, if each meta-label is a timestamp “year 2000,” “year 2001,” “year 2002,” “year 2003,” etc., then the set of allowable meta-labels could specify a single year, for example, “year 2001,” or a range of years (e.g., “year 2002” and “year 2003”). The selection engine 106 can select the training data 108 for the training stage, for example, by selecting some or all of the training examples having allowable meta-labels for inclusion in the training data for the training stage. In particular, the selection engine 106 can exclude any training example having a meta-label that is not included in the set of allowable meta-labels from the training data for the training stage.

In some implementations, in addition specifying a set of allowable meta-labels, the selection criterion for a training stage can further specify a respective “selection weight” for each allowable meta-label. The selection weight for an allowable meta-label can be represented, e.g., as a numerical value. The selection engine 106 can assign a respective selection weight to each training example having an allowable meta-label, and then select the training data for the training stage by sampling from the set of training examples with allowable meta-labels in accordance with a probability distribution defined by the selection weights. For example, the selection engine 106 can sample a predefined number of training examples in accordance with the probability distribution defined by the selection weights. The selection engine 106 can ensure the selection weights for the training examples with allowable meta-data labels define a probability distribution, for example, by processing the selection weights for the training examples with allowable meta-data labels using a soft-max function.

Generally, the selection engine 106 implements a different selection criterion at each training stage. In some cases, the selection criteria change, over the course of the sequence of training stages, to place more emphasis on selection of training examples with progressively increasing (or decreasing) meta-labels. Thus, if the meta-labels represent timestamps, the selection engine 106 can increasingly emphasize the selection of more recent training examples over the course of the sequence of training stages.

A few example techniques by which the selection engine 106 can, over the course of the sequence of training stages, place more emphasis on selection of training examples with progressively increasing meta-labels are described next. In one example, for each training stage after the first training stage, the maximum meta-label in the set of allowable meta-labels for the training stage may be greater than the maximum meta-label in the set of allowable meta-labels for the preceding training stage. In another example, for at least one training stage, the selection weight corresponding to the maximum meta-label in the set of allowable meta-labels may be greater than the selection weight corresponding to the minimum meta-label in the set of meta-labels.

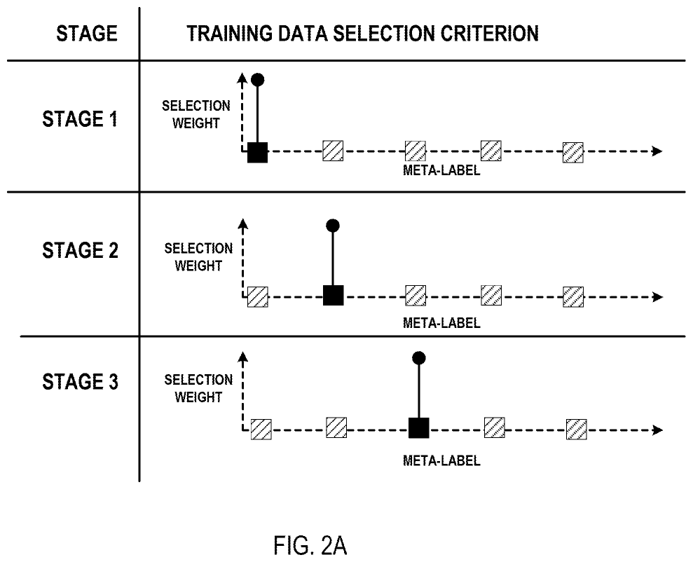

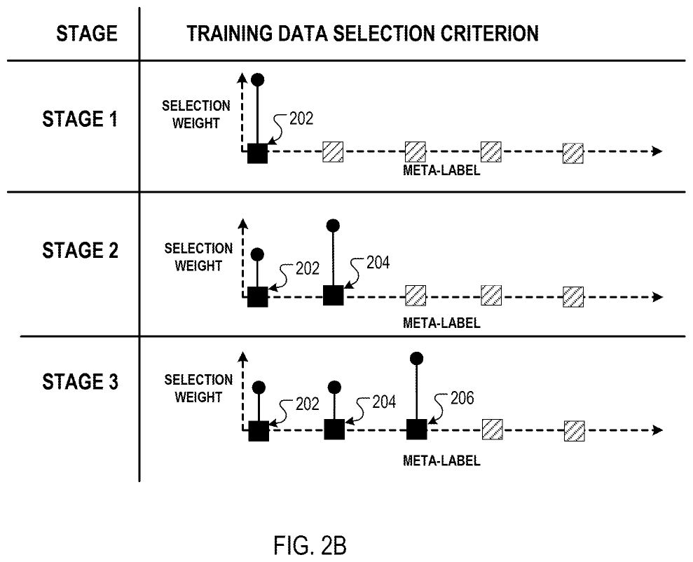

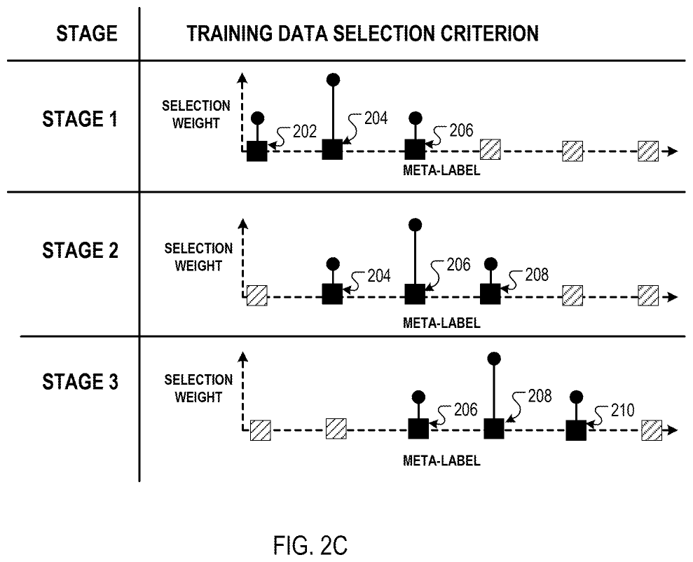

Examples of selection criteria implemented by the selection engine 106 at respective training stages are illustrated with reference to FIG. 2A-2C, which are described in more detail below.

At each training stage, the training engine 110 updates the machine learning model 112 by training the machine learning model 112 on the training data 108 for the training stage. More specifically, at each training stage before the last training stage, the training engine 110 trains the machine learning model 112 on the training data 108 for the training stage, and then provides the updated machine learning model for further training at the next training stage.

As part of training the machine learning model 112 on the training data 108 for a training stage, the training engine 110 can determine a respective error in the model output generated by the machine learning model for each training example in the training data for the training stage. The training engine 110 can then use the errors in the model outputs to guide the training of the machine learning model at the training stage. For example, if the machine learning model 112 is an ensemble model, the training engine 110 can train one or more new base models that, when added to the ensemble model, have the effect of “correcting” the errors in the model outputs generated by the ensemble model.

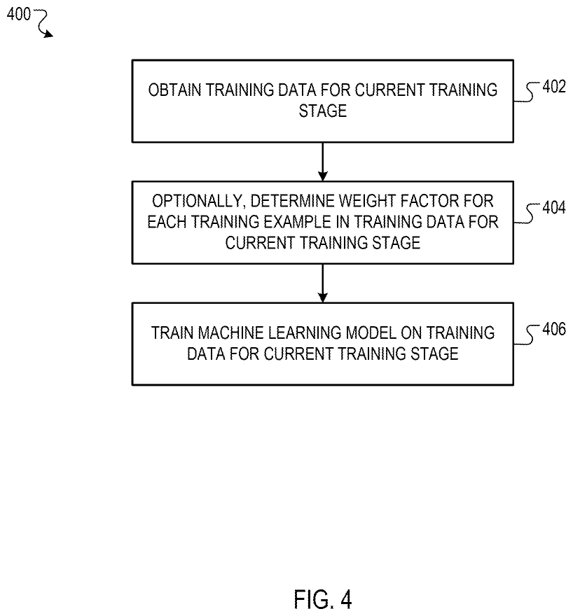

Example techniques for training the machine learning model 112 on the training data 108 for a training stage and guiding the training using the errors in the model outputs generated by the machine learning model are described in more detail below with reference to FIG. 4.

After the final training stage in the sequence of training stages, the training system 100 can output the trained machine learning model 112. For example, the training system can store data defining the training machine learning model in a memory, or can provide the trained machine learning model for performing the machine learning task (e.g., in a data center).

Optionally, at each training stage, the training system 100 can “validate” the machine learning model 112 after training the machine learning model 112 on the training data 108 for the training stage, for example, by testing the performance of the machine learning model on a set of validation examples. Each validation example is a training example, from the set of training data 102, that was not used for training the machine learning model 112 as of the training stage. For example, each validation example may be a training example having a meta-label that was not included in the set of allowable meta-labels for any training stage up to and including the current training stage. The training system 100 can test the performance of the machine learning model 112 on the validation data, for example, by measuring the prediction accuracy of the machine learning model 112 on the validation data. Validating the machine learning model 112 on the validation data can enable a user to determine whether the machine learning model 112 has achieved an acceptable performance (e.g., prediction accuracy).

FIG. 2A-C illustrate examples of training data selection criteria. In particular, for each training stage, the training data selection criterion at the training stage is illustrated by a plot, where meta-labels are shown on the x-axis (i.e., horizontal axis) and selection weights for the meta-labels are shown on the y-axis (i.e., vertical axis). At each training stage, allowable meta-labels for the training stage are illustrated as shaded boxes, while other (i.e., non-allowable) meta-labels are shown as hatched boxes. The set of meta-labels can represent, for example, timestamps of training examples. A meta-label can be referred to as an “allowable” meta-label at a training stage, for example, if training examples with the meta-label are eligible to be selected for inclusion in the training data for the training stage, as described above with reference to FIG. 1. The selection weights for the allowable meta-labels at a training stage can define, for each allowable meta-label, a likelihood that training examples having the meta-label will be sampled for inclusion in the training data for the training stage, as described above with reference to FIG. 1.

In FIG. 2A, at each training stage, the corresponding training data selection criterion designates a single meta-label as being an allowable meta-label. In this example, because only a single meta-label is designated as being an allowable meta-label at each training stage, the selection weight for the allowable meta-label at each training stage may be a default value, for example, that does not impact the selection of training examples. It can be appreciated that, in FIG. 2A, the training data selection criteria sequentially traverse the set of meta-labels in accordance with the ordering of the meta-labels. In a particular example, the meta-labels may represent timestamps (e.g., “year 2000,” “year 2001,” “year 2002,” etc.), and the training data selection criteria sequentially traverse the timestamps, for example, from the least recent timestamp to the most recent timestamp. At each training stage, the training system can designate training examples having a timestamp corresponding to the training stage for inclusion in the training data for the training stage.

In FIG. 2B, at the first training stage, the training data selection criterion designates only meta-label 202 as being allowable. At the second training stage, the training data selection criterion designates both meta-labels 202 and 204 as being allowable, and assigns a higher selection weight to meta-label 204 than to meta-label 202. At the third training stage, the training data selection criterion designates meta-labels 202, 204, and 206 as being allowable, and assigns a higher selection weight to meta-label 206 than to meta-labels 202 and 204. In some examples, the meta-labels may represent timestamps, and the training data selection criteria sequentially traverse the timestamps. At each training stage, the training system can designate training examples having: (i) a timestamp corresponding to the training stage, or (ii) a timestamp that precedes the timestamp corresponding to the training stage, for inclusion in the training data for the training stage.

In FIG. 2C, at the first training stage, the training data selection criterion designates meta-labels 202, 204, and 206 as allowable meta-labels, and assigns a higher selection weight to meta-label 204 than to meta-labels 202 and 206. At the second training stage, the training data selection criterion designates meta-labels 204, 206, and 208 as allowable meta-labels, and assigns a higher selection weight to meta-label 206 than to meta-labels 204 and 208. At the third training stage, the training data selection criterion designates meta-labels 206, 208, and 210 as allowable meta-labels, and assigns a higher selection weight to meta-label 208 than to meta-labels 206 and 210. In a particular example, the meta-labels may represent timestamps, and the training data selection criteria sequentially traverse the timestamps. At each training stage, the training system can designate training examples having: (i) a “main” timestamp corresponding to the training stage, or (ii) an “auxiliary” timestamp that immediately precedes or follows the main timestamp corresponding to the training stage, for inclusion in the training data for the training stage.

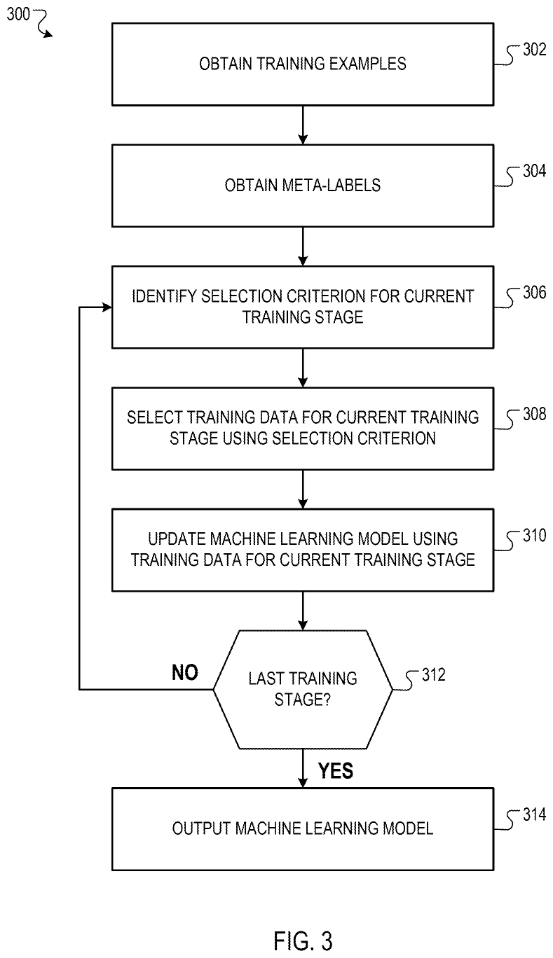

FIG. 3 is a flow diagram of an example process 300 for training a machine learning model to perform a machine learning task. For convenience, the process 300 will be described as being performed by a system of one or more computers located in one or more locations. For example, a training system, for example, the training system 100 of FIG. 1, appropriately programmed in accordance with this specification, can perform the process 300.

The system obtains a set of training examples (302). The set of training examples may be provided, for example, by a user of the system.

The system obtains, for each training example, a respective meta-label that characterizes the training example (304). The meta-label for a training example can be any appropriate descriptive data characterizing the training example, for example, a timestamp or geographic feature associated with the training example.

The system trains the machine learning model over a sequence of training stages. For convenience, steps 306-312 are described with reference to a “current” training stage in the sequence of training stages.

The system identifies a selection criterion corresponding to the current training stage that defines a criterion for selecting training examples based on the metadata labels of the training examples (306). In some implementations, the selection criterion for the current training stage specifies a set of allowable metadata labels for the training stage. Each training example is eligible for selection at the current training stage only if the metadata label of the training example is included in the set of allowable metadata labels for the training stage.

The system selects a proper subset of the set training examples as training data for the current training stage in accordance with the selection criterion for the current training stage (308).

The system updates the machine learning model by training the machine learning model on the training data for the current training stage (310). An example process for training the machine learning model on the training data for the current training stage is described with reference to FIG. 4.

The system determines whether the current training stage is the last training stage (312). In response to determining that the current training stage is not the last training stage, the system provides the updated machine learning model for further training at a next training stage in the sequence of training stages, and returns to step 306. In response to determining that the current training stage is the last training stage, the system outputs the machine learning model (316), for example, by providing the trained machine learning model for use in performing the machine learning task, e.g., in a data center.

FIG. 4 is a flow diagram of an example process 400 for updating a machine learning model by training the machine learning model on training data for a current training stage. For convenience, the process 400 will be described as being performed by a system of one or more computers located in one or more locations. For example, a training system, for example, the training system 100 of FIG. 1, appropriately programmed in accordance with this specification, can perform the process 400.

The system obtains training data for the current training stage (402). For example, the system can select the training data for the current training stage from a set of training examples, where each training example has a corresponding meta-label. The system can select the training data for the current training stage by selecting a proper subset of the training examples in accordance with a selection criterion, for the current training stage, that is based on the meta-labels of the training examples, as described above. Each training example in the training data for the current training stage includes: (i) a training input to the machine learning model, and (ii) a target output.

Optionally, the system determines a respective weight factor for each training example in the training data for the current training stage (404). The weight factor for a training example can be represented as a numerical value, and can control an impact of the training example on the training of the machine learning model, as will be described in more detail below.

In some implementations, to determine the weight factor for a training example, the system processes the training input from the training example using the machine learning model to generate a predicted output. The system then determines the weight factor for the training example based on an error between: (i) the predicted output for the training example, and (ii) the target output for the training example. The system can determine the error between the predicted output and the target output in any appropriate way, for example, as a cross-entropy error or a squared error. The system can determine the weight factor based on the error in any appropriate way. Generally, the weight factor for the training example and the error for the training example are positively correlated, such that a higher error results in a higher weight factor. For example, the system can determine the weight factor for the training example as a magnitude of the error for the training example.

In some implementations, the system determines the weight factor for a training example based at least in part on the selection weight associated with the meta-label of the training example. More specifically, in combination with or as an alternative to using the selection weights for the training examples to determine a probability distribution for sampling training examples, as described above, the system can use the selection weights for the training examples to determine weight factors for the training examples. For example, the system can determine the weight factor for a training example as being equal to the selection weight for the meta-label of the training example. As another example, the system can determine the weight factor for a training example as being equal to a function (e.g., a sum or a product) of the error for the training example (as described above) and the selection weight for the meta-label of the training example.

The system trains the machine learning model on the training data for the current training stage (406). A few example techniques by which the system can train the machine learning model on the training data for the current training stage are described next.

In some implementations, the system trains the machine learning model to, for each training example in the training data for the current training stage, process the training input from the training example to generate the target output from the training example.

The system can train the machine learning model to generate the target outputs from the training examples using any appropriate machine learning training technique. For example, if the machine learning model includes a neural network, then to train the neural network on a training example in the training data for the current training stage, the system can process the training input from the training example using the neural network to generate a predicted output. The system can determine gradients (i.e., with respect to the parameters of the neural network) of an objective function that measures an error between the predicted output for the training example and the target output for the training example. The system can determine the gradients, for example, using backpropagation. The system can then use the gradients to update the parameter values of the neural network, for example, using any appropriate gradient descent optimization technique (e.g., RMSprop, Adam).

In some examples, the system can incorporate the weight factors for the training examples (as described with reference to step 404) into the training of the machine learning model. For example, as part of training a neural network on a training example, the system can scale the gradients of the objective function (i.e., that measures an error between the predicted output and the target output for the training example) by the weight factor for the training example. Thus training examples associated with higher weight factors can have a higher impact on the training of the neural network, for example, by causing larger shifts in the parameter values of the neural network.

In some implementations, the machine learning model is an ensemble model that includes a set of models, as described with reference to FIG. 1. In some implementations, the system can train one or more new base models on the training data for the current training stage, and then add the new base models to the ensemble model. The new base models can be, for example, decision trees, neural networks, support vector machines, or the like.

As part of training the new base models, the system can determine a respective prediction target for each training example in the training data for the current training stage. The system can determine the prediction target for a training example based on an error in the prediction generated by the ensemble model for the training example. More specifically, to generate the prediction target for a training example, the system can process the training input from the training example using the ensemble model to generate a predicted output. The system can determine an error (e.g., a difference) between: (i) the predicted output for the training example, and (ii) the target output for the training example. The system can then determine the prediction target for the training example based on the prediction error for the training example, for example, as the negative of the prediction error for the training example.

After generating the prediction targets for the training examples, the system can train each new base model to, for each training example, process the training input for the training example to generate the prediction target for the training example. That is, the system trains the new base models to learn the “error” in the predictions generated by the ensemble model. The system can train the new base models using any appropriate machine learning training technique.

The system can add the new base models to the ensemble model after the new base models have been trained to learn the errors in the predictions generated by the ensemble model. The updated ensemble model Fₙ(·) may have the form:

Fₙ(x)=Fₙ₋₁(x)+γₙ·fₙ(x) (2)

where x is the model input, Fₙ₋₁(·) is the ensemble model prior to being updated at the training stage, γₙ is a scaling factor, and fₙ(·) is the new base model. If the system generates multiple new base models, then fₙ(·) can be, for example, a combination (e.g., average) of the new base models. The scaling factor γₙ can be determined in any appropriate way, for example, as a function of the error rate of the new base models, or as a predefined hyper-parameter.

Optionally, the system can incorporate the weight factors for the training examples (as described with reference to step 404) into the training of the new base models, as described above.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers for training a machine learning model to perform a machine learning task, the method comprising:
obtaining a set of training examples;
obtaining, for each training example, a respective metadata label that characterizes the training example; and
training the machine learning model over a sequence of training stages, comprising, at each training stage before a last training stage in the sequence of training stages:
identifying a selection criterion corresponding to the current training stage that defines a criterion for selecting training examples based on the metadata labels of the training examples,
selecting a proper subset of the set training examples as training data for the current training stage in accordance with the selection criterion for the current training stage,
updating the machine learning model by training the machine learning model on the training data for the current training stage, and
providing the updated machine learning model for further training at a next training stage in the sequence of training stages.

2. The method of claim 1, wherein for each training example, the metadata label for the training example defines a timestamp corresponding to the training example.

3. The method of claim 1, wherein for each training example, the metadata label for the training example defines a geographic feature corresponding to the training example.

4. The method of claim 1, wherein for each training stage in the sequence of training stages:
the selection criterion corresponding to the training stage specifies a set of allowable metadata labels for the training stage; and
each training example is eligible for selection at the training stage only if the metadata label of the training example is included in the set of allowable metadata labels for the training stage.

5. The method of claim 4, wherein for each training stage after a first training stage in the sequence of training stages:
a maximum metadata label in the set of allowable metadata labels for the training stage is greater than a maximum metadata label in the set of allowable metadata labels for a preceding training stage.

6. The method of claim 4, wherein for one or more training stages in the sequence of training stages:
the selection criterion corresponding to the training stage specifies a respective selection weight for each metadata label in the set of allowable metadata labels; and
selecting a proper subset of the set of training examples as training data for the current training stage comprises:
determining a probability distribution, over training examples having metadata labels included in the set of allowable metadata labels for the training stage, using the selection weights for the allowable metadata labels; and
sampling a plurality of training examples having metadata labels included in set of allowable metadata labels in accordance with the probability distribution.

7. The method of claim 6, wherein for one or more training stages in the sequence of training stages:
the set of allowable metadata labels for the training stage comprises a plurality of metadata labels; and
the selection criterion corresponding to the training stage specifies a higher selection weight for a maximum metadata label in the set of allowable metadata labels than for a minimum metadata label in the set of allowable metadata labels.

8. The method of claim 1, wherein for one or more training stages in the sequence of training stages, updating the machine learning model by training the machine learning model on the training data for the current training stage comprises:
determining, for each training example in the training data for the current training stage, an error in a prediction generated by the machine learning model for the training example;
updating the machine learning model using the errors in the predictions generated by the machine learning model for the training examples in the training data for the current training stage.

9. The method of claim 8, wherein the machine learning model is an ensemble model that comprises a plurality of base models, and wherein updating the machine learning model using the errors in the predictions generated by the machine learning model for training examples in the training data for the current training stage comprises:
determining a prediction target for each training example in the training data for the current training stage based on the error in the prediction generated by the machine learning model for the training example;
generating one or more new base models that are each trained to generate the prediction targets for the training examples in the training data for the current training stage; and
adding the new base models to the ensemble model.

10. The method of claim 9, wherein the new base models are decision trees.

11. The method of claim 8, wherein updating the machine learning model using the errors in the predictions generated by the machine learning model for the training examples in the training data for the current training stage comprises:
determining a respective weight factor for each training example in the training data for the current training stage based on the error in the prediction generated by the machine learning model for the training example;
training the machine learning model on the training data for the current training stage using the weight factors for the training examples, wherein the weight factor for a training example controls an impact of the training example on the training of the machine learning model.

12. The method of claim 11, wherein the machine learning model comprises a neural network, and wherein training the machine learning model on the training data for the current training stage using the weight factors for the training examples comprises, for each training example:
generating a prediction for the training example using the neural network;
determining gradients, with respect to neural network parameters of the neural network, of an objective function that depends on the prediction for the training example;
scaling the gradients using the weight factor for the training example; and
updating the neural network parameters of the neural network using the scaled gradients.

13. The method of claim 1, wherein training the machine learning model at the last stage in the sequence of training stages comprises:
identifying a selection criterion corresponding to the last training stage that defines a criterion for selecting training examples based on the metadata labels of the training examples;
selecting a proper subset of the set training examples as training data for the last training stage in accordance with the selection criterion for the current training stage;
updating the machine learning model by training the machine learning model on the training data for the last training stage; and
providing the updated machine learning model for use in performing the machine learning task.

14. The method of claim 1, wherein each training example in the set of training examples comprises: (i) a training input to the machine learning model, and (ii) a target output to be generated by the machine learning model by processing the training input.

15. The method of claim 14, wherein the machine learning model performs a fire prediction task, wherein for each training example: (i) the training input characterizes a geographic region, and (ii) the target output defines, for each of one or more spatial locations in the geographic region, whether the spatial location will be impacted by fire within a time window.

16. The method of claim 14, wherein the machine learning model performs a flood prediction task, wherein for each training example: (i) the training input characterizes a geographic region, and (ii) the target output defines, for each of one or more spatial locations in the geographic region, whether the spatial location will be impacted by flooding within a time window.

17. The method of claim 14, wherein the machine learning model performs a health prediction task, wherein for each training example: (i) the training input comprises electronic medical record data characterizing a subject, and (ii) the target output defines a prediction for whether the subject will receive a medical diagnosis within a time window.

18. The method of claim 14, wherein for each training example, the training input to the machine learning model comprises an image, or features derived from an image.

19. A system comprising:
one or more computers; and
one or more storage devices communicatively coupled to the one or more computers, wherein the one or more storage devices store instructions that, when executed by the one or more computers, cause the one or more computers to perform operations for training a machine learning model to perform a machine learning task, the operations comprising:
obtaining a set of training examples;
obtaining, for each training example, a respective metadata label that characterizes the training example; and
training the machine learning model over a sequence of training stages, comprising, at each training stage before a last training stage in the sequence of training stages:
identifying a selection criterion corresponding to the current training stage that defines a criterion for selecting training examples based on the metadata labels of the training examples,
selecting a proper subset of the set training examples as training data for the current training stage in accordance with the selection criterion for the current training stage,
updating the machine learning model by training the machine learning model on the training data for the current training stage, and
providing the updated machine learning model for further training at a next training stage in the sequence of training stages.

20. One or more non-transitory computer storage media storing instructions that when executed by one or more computers cause the one or more computers to perform operations for training a machine learning model to perform a machine learning task, the operations comprising:
obtaining a set of training examples;
obtaining, for each training example, a respective metadata label that characterizes the training example; and
training the machine learning model over a sequence of training stages, comprising, at each training stage before a last training stage in the sequence of training stages:
identifying a selection criterion corresponding to the current training stage that defines a criterion for selecting training examples based on the metadata labels of the training examples,
selecting a proper subset of the set training examples as training data for the current training stage in accordance with the selection criterion for the current training stage,
updating the machine learning model by training the machine learning model on the training data for the current training stage, and
providing the updated machine learning model for further training at a next training stage in the sequence of training stages.
